(19) United States
(12) Patent Application Publication
(10) Pub. No.: US 2025/0232147 A1
(43) Pub. Date: Jul. 17, 2025

(54) AUTHENTICATION/TRACKING OF A PRODUCT OR PACKAGE USING WAVE-SHIFTING MARKER CRYSTALS INCORPORATED INTO A COMPONENT OF THE PRODUCT OR PACKAGE

(71) Applicant: SiO2 Medical Products, Inc., Auburn, AL (US)

(72) Inventors: Robert S. Abrams, Auburn, AL (US); Ahmad Taha, Auburn, AL (US); Peter J. Sagona, Auburn, AL (US); Howard Bell, Princeton, NJ (US); Alexandra Bell, Princeton, NJ (US); Josh Collins, Wallingford, PA (US); Thomas E. Fisk, Auburn, AL (US)

(21) Appl. No.: 18/871,255

(22) PCT Filed: Jun. 5, 2023
(86) PCT No.: PCT/US2023/067947

§ 371 Date: Dec. 3, 2024

Related U.S. Application Data
(60) Provisional application No. 63/348,706, filed on Jun. 3, 2022.
(60) Provisional application No. 63/430,990, filed on Dec. 7, 2022.

(51) Int. Cl. G06K 19/06; G01N 21/64

(52) U.S. Cl. CPC G06K 19/06112; G01N 21/6408; G01N 21/643; G01N 2021/6439

(57) ABSTRACT

Products, such as a watch, an item of jewelry, a pair of eyeglasses or sunglasses, or the like, may be configured to be authenticated and/or tracked by way of producing a light emission having one or more predetermined characteristics. More particularly, a product may comprise a metal component, at least a portion of which contains wave-shifting marker crystals configured to emit light having one or more characteristics by which the product may be identified. Also described are packages, such as for cosmetics or fragrances, containing wave-shifting crystals that, when excited, emit light having one or more characteristics by which information about the package, such as a unique package identifier, may be obtained.

This application is a United States national stage entry of International Application No. PCT/US2023/067947, filed on Jun. 5, 2023, which claims priority to U.S. Provisional Application No. 63/430,990, filed on Dec. 7, 2022, and U.S. Provisional Application No. 63/348,706, filed on Jun. 3, 2022, the entireties of each of which are incorporated by reference herein.

### FIELD OF THE INVENTION

Luxury products are popular targets for counterfeiting and diversion. Billions of dollars are lost each year to counterfeit products. The ability to trace and authenticate high-value, e.g. designer and luxury, products, including for example cosmetics, fragrances, clothing, shoes, handbags, eyeglasses/sunglasses, jewelry, and watches, has become increasingly important as counterfeit goods become more sophisticated. The present disclosure presents a covert means of authenticating luxury products that cannot be readily copied, is cost effective, and is easily scalable.

Embodiments of the present disclosure relate to the incorporation of luminescent wave-shifting crystals, including for instance rare earth doped crystals, into high-value products, including for example cosmetics, fragrances, clothing, shoes, handbags, eyeglasses/sunglasses, jewelry, and watches, and to the use of the luminescent wave-shifting crystals, e.g. rare earth doped nanoparticle crystals, for the authentication and/or tracking of those products. More particularly, embodiments of the present disclosure relate to the incorporation of luminescent wave-shifting crystals directly into the metal used to produce a metal component of the product.

Embodiments of the present disclosure also relate to the incorporation of luminescent wave-shifting crystals, including for instance rare earth doped crystals, into packages for high-value products, including cosmetics, fragrances, consumer goods, diagnostics, and luxury watches, and to the use of the luminescent wave-shifting crystals, e.g. rare earth doped nanoparticle crystals, for the authentication and/or tracking of the products within the packages.

### SUMMARY OF THE INVENTION

Embodiments of the present disclosure are directed to products configured to be authenticated and/or tracked by way of producing a light emission having one or more predetermined characteristics, the product comprising a metal component, in which at least a portion of the metal component comprises a metal material containing wave-shifting marker crystals configured to emit light having one or more characteristics by which the product may be identified.

In some embodiments, the wave-shifting marker crystals are rare earth doped crystals, optionally rare earth doped nanoparticle crystals.

In some embodiments, the metal material is stainless steel or an alloy thereof, gold or an alloy thereof, platinum or an alloy thereof, silver or an alloy thereof, or any combination thereof. In some embodiments, the metal material is stainless steel. In some embodiments, the metal material is gold. In some embodiments, the metal is silver. In some embodiments, the metal is platinum.

In some embodiments, the product is a wearable item, optionally a watch, optionally an item of jewelry, optionally a pair of eyeglasses or sunglasses.

In some embodiments, the product is a handbag or item of clothing.

The wave-shifting marker crystals are configured to withstand the melting temperature of the metal in which they are incorporated. In some embodiments, the wave-shifting marker crystals may be configured to withstand temperatures at least as high as 900° C., optionally at least as high as 961° C., optionally at least as high as 1,000° C., optionally at least as high at 1,064° C., optionally at least as high as 1,400° C., optionally at least as high as 1,500° C., optionally at least as high as 1,550° C., optionally at least as high as 1,768° C.

In some embodiments, the wave-shifting marker crystals may be blended into the metal material when the metal material is in a molten state. As such, the wave-shifting marker crystals may be randomly distributed in the metal material. The wave-shifting marker crystals may thus be distributed in the metal material to produce a unique light map when excited.

In some embodiments, the wave-shifting marker crystals may be present in the metal in an amount of 5 wt. % or less, optionally between 1 wt. % and 5 wt. %, optionally 4 wt. % or less, optionally between 1 wt. % and 4 wt. %, optionally 3 wt. % or less, optionally between 1 wt. % and 3 wt. %, optionally 2 wt. % or less, optionally between 1 wt. % and 2 wt. %, optionally 1 wt. % or less, optionally between 100 ppm and 1 wt. %, optionally less than 1 wt. %, optionally 1000 ppm or less, optionally between 500 ppm and 1000 ppm, optionally 500 ppm or less, optionally between 100 ppm and 500 ppm, optionally 100 ppm or less, optionally between 50 ppm and 100 ppm.

In some embodiments, the presence of the wave-shifting marker crystals does not change the physical properties of the metal component as they relate to use of the product, e.g. physical strength, etc.

In some embodiments, the wave-shifting marker crystals are configured and distributed in the metal material such that, when the wave-shifting marker crystals are unexcited, the presence of the wave-shifting marker crystals cannot be detected by the average human eye.

In some embodiments, the wave-shifting marker crystals are configured and distributed in the metal material such that the emission of individual crystals can be detected.

In some embodiments, the marker crystals have dimensions/diameters of 50 microns or less, alternatively 40 microns or less, alternatively 30 microns or less, alternatively 20 microns or less, alternatively 10 microns or less, alternatively 8 microns or less, alternatively 5 microns or less, alternatively 2 microns or less, alternatively 1 micron or less. In some embodiments, the marker crystals have dimensions/diameters between 0.5 and 10 microns, alternatively between 1 and 10 microns, alternatively between 5 and 10 microns, alternatively between 0.5 and 5 microns, alternatively between 1 and 5 microns, alternatively between 0.5 and 2 microns, alternatively between 0.5 and 1 micron.

In some embodiments, the metal material may comprise a first wave-shifting marker crystal and a second wave-shifting marker crystal, wherein the first wave-shifting marker crystal and the second wave-shifting marker crystal produce emissions having one or more different properties. The first and second wave-shifting marker crystals may be configured and distributed in the metal material such that a ratio between the first wave-shifting marker crystal and the second wave-shifting marker crystal can be determined when the wave-shifting marker crystals are excited.

In some embodiments, the marker crystals may be configured/tuned to react to one or more specific wavelengths of light. For example, the marker crystals may be configured/tuned to react to light having a wavelength within the ultraviolet spectrum, light having a wavelength within the visible spectrum, light having a wavelength within the infrared spectrum, or any combination thereof.

In some embodiments, the marker crystals are configured/tuned to produce an emission in one or more defined wavelength bands/ranges. For example, the marker crystals may be configured/tuned to have a defined rise time, decay time, or both; the marker crystals may be configured/tuned to produce an emission having an intensity within a defined range; the marker crystals may be configured/tuned to produce an emission having dimensions within a defined range; or any combination thereof.

In some embodiments, the wave-shifting crystals are luminescent. The wave-shifting crystals may be configured/tuned to luminesce to one or more specific wavelengths of light. For example, the wave-shifting crystals may be configured/tuned to luminesce in response to light having a wavelength within the ultraviolet spectrum, light having a wavelength within the visible spectrum, light having a wavelength within the infrared spectrum, or any combination thereof.

In some embodiments, the wave-shifting crystals may be configured/tuned to luminesce solely in response to light having a wavelength within the ultraviolet spectrum. In other embodiments, the wave-shifting crystals may be configured/tuned to luminesce solely in response to light having a wavelength within the visible spectrum. In other embodiments, the wave-shifting crystals may be configured/tuned to luminesce solely in response to light having a wavelength within the infrared spectrum. In other embodiments, the wave-shifting crystals may be configured/tuned to luminesce only in response to light having a wavelength within a defined wavelength range.

In some embodiments, the wave-shifting crystals may be cathodoluminescent.

In some embodiments, the wave-shifting crystals may be down-converting phosphors. In other embodiments, the wave-shifting crystals may be up-converting phosphors.

In some embodiments, the wave-shifting crystals may be configured/tuned to produce an emission in one or more defined wavelength bands/ranges.

In some embodiments, the wave-shifting crystals may be configured/tuned to have a defined rise time, decay time, or both.

In some embodiments, the wave-shifting crystals may be configured/tuned to produce an emission having an intensity within a defined range.

In some embodiments, the wave-shifting crystals may be configured/tuned to produce an emission having dimensions within a defined range.

In some embodiments, the wave-shifting crystals may be configured and present in an amount sufficient such that their luminescence is detectable by a hand-held authentication device, an industrial authentication device, optionally a mobile authentication device, optionally a smartphone or similar device, or any combination of devices.

The wave-shifting crystals may be rare earth doped crystals. The wave-shifting crystals may be wave-shifting nanoparticle crystals. The wave-shifting crystals may be rare earth doped nanoparticle crystals.

The rare earth doped crystals, optionally rare earth doped nanoparticle crystals, may comprise a rare earth element-containing lattice and a dopant. The dopant may also comprise a rare earth element.

In some embodiments, the rare earth element-containing lattice may contain a first rare earth element and the dopant may comprise a second rare earth element, whereby the second rare earth element differs from the first rare earth element. The first rare earth element may, for example, be selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof. The second rare earth element may, for example, be selected from the group consisting of: lanthanum, cerium, praseodymium, neodymium, promethium, samarium, europium, gadolinium, terbium, dysprosium, holmium, erbium, thulium, ytterbium, lutetium, scandium, yttrium, or any subgroup thereof.

In some embodiments, the lattice may comprise NaYF₄.

In some embodiments, the dopant may comprise two or more different rare earth elements. In some embodiments, the dopant may comprise Yb and a second rare earth element. For example, the dopant may comprise one of the following combinations: Er and Yb; Tm and Yb, Nd and Yb, Ho and Yb, or Pr and Yb.

In some embodiments, the rare earth doped crystals comprise a lattice and one or more rare earth element dopants. In some embodiments, for example, the lattice may comprise NaLiF. In some embodiments, for example, the dopant may comprise Nd or Pr. In some embodiments, for example, the lattice may comprise Y2O3. In some embodiments, for example, the dopant may comprise Er and Yb. In some embodiments, for example, the lattice may comprise Gd, optionally Gd₂SO₂ or Gd₂O₃. In some embodiments, for example, the wave-shifting crystal comprises one or more of Gd₂SO₂:Yb,Er; Gd₂SO₂:Er; Gd₂SO₂:Yb,Nd; Gd₂O₃:Yb,Er; Gd₂SO₂:Yb, Ho, NaYF₄:Yb, Nd; and NaYF₄:Yb, Er.

In some embodiments, the rare earth doped crystals have a polyhedral morphology.

In some embodiments, the rare earth doped crystals may have a uniform morphology.

In some embodiments, the wave-shifting crystals may be configured to produce an emission in response to interrogation by a device, optionally a smartphone, having an IR illuminator, a VCSEL, an LED light, or a combination thereof.

In some embodiments, the wave-shifting crystals may be configured and present in an amount to produce an emission that is readable by a device, optionally a smartphone, having a CMOS sensor or CMOS camera.

In some embodiments, the wave-shifting crystals may be of a uniform or substantially uniform size, in which substantially uniform means within a tolerance of about 10 nm or less.

Embodiments of the present disclosure are also directed to a plurality of products as described herein in which the wave-shifting crystals in a first product produce an emission having a first optical property when interrogated and the wave-shifting crystals in a second product produce an emission having a second optical property when interrogated, the second optical property being different from the first optical property such that the first product and the second product can be distinguished from one another.

In some embodiments, the first and second optical properties may be light maps produced by the specific distribution of individual wave-shifting crystals in the metal matrix material. In some embodiments, the first and second optical properties may be ratios of first and second wave-shifting marker crystals present in one or more of the first and second products. In some embodiments, the first and second optical properties may be any of the following: a wavelength of an emission, a size (i.e., dimensions) of an emission, a power or intensity of an emission, a rise time of an emission, a decay time of an emission, a wavelength and/or source of excitation light, or any combination thereof.

Embodiments of the present disclosure are also directed to methods of authenticating and/or tracking a product or plurality of products as described herein, the method comprising: providing a product comprising a metal component, in which at least a portion of the metal component comprises a metal material containing wave-shifting marker crystals configured to emit light having one or more characteristics by which the product may be identified; interrogating the product to detect the luminescence characteristics of the emission profile produced by the wave-shifting marker crystals; and identifying and/or authenticating the product based on the luminescence characteristics of the emission profile produced by the wave-shifting marker crystals.

In some embodiments, the one or more luminescence characteristics may comprise or consist of a light map produced by the specific distribution of individual wave-shifting crystals in the metal material. In some embodiments, the one or more luminescence characteristics may comprise or consist of a ratio between a first and a second wave-shifting marker crystal. In some embodiments, the one or more luminescence characteristics may comprise or consist of any of the following: emission within one or more defined wavelength bands, emission having a defined rise time, emission having a defined decay time, emission having a defined intensity at a given time, emission in a defined spatial pattern, e.g. light map, or any combination thereof.

In some embodiments, the step of interrogating may involve applying light having one or more discrete wavelengths to the product to excite the wave-shifting marker crystals, and detecting one or more luminescence characteristics of the light emitted by the wave-shifting marker crystals.

In some embodiments, the one or more discrete wavelengths may be selected from one or more wavelengths within the ultraviolet spectrum, one or more wavelengths within the visible spectrum, one or more wavelengths within the infrared spectrum, or any combination thereof. For example, the one or more discrete wavelengths may be selected from one or more wavelengths within the ultraviolet spectrum. Alternatively, the one or more discrete wavelengths may be selected from one or more wavelengths within the visible spectrum. Alternatively, the one or more discrete wavelengths may be selected from one or more wavelengths within the infrared spectrum.

In some embodiments, the light emitted by the wave-shifting crystals may have one or more discrete wavelengths selected from one or more wavelengths within the ultraviolet spectrum, one or more wavelengths within the visible spectrum, one or more wavelengths within the infrared spectrum, or any combination thereof. For example, the light emitted by the wave-shifting crystals may have one or more discrete wavelengths within the ultraviolet spectrum. Alternatively, the light emitted by the wave-shifting crystals may have one or more discrete wavelengths within the visible spectrum. Alternatively, the light emitted by the wave-shifting crystals may have one or more discrete wavelengths within the infrared spectrum.

In some embodiments, the applying light and the detecting may be performed by the same device.

In some embodiments, the device that detects the light emitted by the wave-shifting marker crystals may be configured to resolve the emissions of individual marker crystals.

In some embodiments, the device that detects the light emitted by the wave-shifting marker crystals may be configured to differentiate between emissions from different types of marker crystals.

Embodiments of the present disclosure are directed to a package comprising a vessel defining a lumen and a high-value product such as a cosmetic product, a fragrance, a consumer good, a luxury watch, an item of jewelry, or the like within the lumen, optionally a closure, and wave-shifting crystals such as those described herein configured to emit light having one or more characteristics by which the package may be identified.

In some embodiments the wave-shifting crystals may be incorporated into a wall of the vessel; optionally wherein the wall of the vessel comprises glass, a thermoplastic material, or a metal.

In some embodiments, the wave-shifting crystals may be present in an ink or coating, and at least a portion of a vessel wall comprises the ink or coating.

In some embodiments, the wall containing the wave-shifting crystals is transparent. For instance, the wall containing the wave-shifting crystals may have at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

In some embodiments the vessel may be blow molded, optionally injection stretch blow molded, from a preform comprising a thermoplastic resin that contains the marker crystals or injection molded from a thermoplastic resin that contains the marker crystals.

In some embodiments, the marker crystals may have dimensions/diameters 50 microns or less, alternatively 40 microns or less, alternatively 30 microns or less, alternatively 20 microns or less, alternatively 10 microns or less, alternatively 8 microns or less, alternatively 5 microns or less, alternatively 2 microns or less, alternatively 1 micron or less, e.g. a D99 of 10 microns or less and/or a D50 of 2 microns or less.

In some embodiments, the marker crystals may be present in or on the wall of the vessel in an amount of about 100 ppm or less, alternatively about 50 ppm or less, alternatively about 40 ppm or less, alternatively about 30 ppm or less, alternatively about 20 ppm or less, alternatively about 10 ppm or less, alternatively between about 1 and 100 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between about 5 and 100 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

In some embodiments, at least a portion of the vessel wall may comprise two or more layers, wherein at least one of the two or more layers is free of the marker crystals, and at least one of the two or more layers contains the marker crystals.

In some embodiments, at least a portion of the wall may include an in-mold label or component containing the marker crystals.

In some embodiments, the marker crystals are configured and present in an amount sufficient such that, when excited, the emission is detectable/readable by a conventional smartphone (e.g. iphone 12) or tablet computer.

In some embodiments, the vessel may comprise one or more non-transparent areas and wherein the marker crystals are present in at least one of the non-transparent areas; wherein optionally the marker crystals are applied to or embedded in at least one of the non-transparent areas; wherein optionally the marker crystals are blended into a thermoplastic material that makes up at least a portion of the non-transparent area; wherein optionally the marker crystals are blended into an ink and applied to a portion of the vessel to produce the non-transparent area.

In some embodiments, the one or more non-transparent areas may comprise letters and/or numbers, a scannable code, or a geometric shape, optionally in which the scannable code is a bar code or QR code.

In some embodiments, the one or more non-transparent areas are channels or recesses burned into the vessel wall by a laser and wherein the marker crystals are applied to or embedded in the channels or recesses.

In some embodiments, the marker crystals may be configured/tuned to react to one or more specific wavelengths of light; wherein optionally the marker crystals are configured/tuned to react to light having a wavelength within the ultraviolet spectrum, light having a wavelength within the visible spectrum, light having a wavelength within the infrared spectrum, or any combination thereof.

In some embodiments, the marker crystals may be configured/tuned to produce an emission in one or more defined wavelength bands/ranges; the marker crystals are configured/tuned to have a defined rise time, decay time, or both; the marker crystals are configured/tuned to produce an emission having an intensity within a defined range; the marker crystals are configured/tuned to produce an emission having dimensions within a defined range, or any combination thereof.

In some embodiments, the vessel may further comprise a cosmetic, fragrance, consumer good, diagnostic, or luxury watch within the lumen.

### BRIEF DESCRIPTION OF THE DRAWINGS

FIG. 1 is an example of a light map produced by a metal sample in which wave-shifting crystals were distributed into a molten stainless steel and, after cooling, the resulting sample was interrogated by an infrared laser to excite the wave-shifting crystals.

FIG. 2 is an example of a watch containing wave-shifting crystals in accordance with an embodiment of the present disclosure.

### DETAILED DESCRIPTION

The present invention will now be described more fully, with reference to the accompanying drawings, in which several embodiments are shown. This invention can, however, be embodied in many different forms and should not be construed as limited to the embodiments set forth here. Rather, these embodiments are examples of the invention, which has the full scope indicated by the language of the claims. Like numbers refer to like or corresponding elements throughout. The following disclosure relates to all embodiments unless specifically limited to a certain embodiment.

Wave-shifting crystals produce specific optical properties when excited by light within a defined wavelength (e.g. infrared, visible, ultraviolet). When excited, the crystals may up-convert the light, down-convert the light, or emit light having a similar wavelength to that with which it was excited but with visually and/or measurably different characteristics. Because the wave-shifting crystals may be configured to be excited by a light having one or more particular characteristics and/or to emit a light having one or more particular characteristics when excited, they are used in embodiments of the present disclosure to authenticate and/or track pharmaceutical products, and in particular pharmaceutical products comprising an injectable agent. By applying a light within the defined wavelength to excite the wave-shifting crystals and examining the light emitted by the crystals, one may identify the crystals as being associated with a particular product or set of products.

Rare earth doped crystals are a type of wave-shifting crystal that may be particularly suitable for one or more of the applications described herein, as each crystal may be tailored to have unique optical properties which allow for the identification of individual products, subsets of products, etc., across a set made up of a large number of total products without risk of misidentification due to shared or overlapping properties.

In some embodiments, wave-shifting crystals may be incorporated into a molten metal which is used to produce a product having a metal component.

In some embodiments the wave-shifting crystals may have dimensions less than 20 microns, alternatively less than 15 microns, alternatively less than 10 microns, alternatively less than 8 microns, alternatively less than 6 microns, alternatively less than 5 microns. For instance the D99 of the crystals may be less than 20 microns, alternatively less than 15 microns, alternatively less than 12 microns, alternatively less than 10 microns, alternatively less than 8 microns, alternatively less than 6 microns, alternatively less than 5 microns.

The wave-shifting crystals may be nanoparticles. For instance, the wave-shifting crystals may have dimensions less than 1000 nm (1 micron), alternatively less than 800 nm, alternatively less than 600 nm, alternatively less than 500 nm, alternatively less than 400 nm, alternatively less than 300 nm, alternatively less than 200 nm, alternatively less than 100 nm, alternatively less than 75 nm, alternatively 50 nm or less. In some embodiments, for instance, the wave-shifting nanoparticles may have dimensions between about 3 nm and about 50 nm.

In some embodiments, the wave-shifting crystals may be present in the metal matrix material at a concentration of at least 5 ppm, alternatively at least 10 ppm, alternatively at least 25 ppm, alternatively at least 50 ppm, alternatively at least 100 ppm, alternatively at least 200 ppm, alternatively at least 300 ppm, alternatively at least 400 ppm, alternatively at least 500 ppm. Similarly the wave-shifting crystals may be present in the matrix material at a concentration of 5 wt. % or less, alternatively 4 wt. % or less, alternatively 3 wt. % or less, alternatively 2 wt. % or less, alternatively 1 wt. % or less, alternatively 1000 ppm or less, alternatively 500 ppm or less, alternatively 100 ppm or less. Any of the above recited lower ends can be combined with any of the above recited upper ends.

In some embodiments, the wave-shifting crystals may be present in the metal matrix in an amount between 1 wt. % and 5 wt. %, alternatively between 1 wt. % and 4 wt. %, alternatively between 1 wt. % and 3 wt. %, alternatively between 1 wt. % and 2 wt. %, alternatively between 100 ppm and 1 wt. %, alternatively between 500 ppm and 1000 ppm, alternatively between 100 ppm and 500 ppm, alternatively between 50 ppm and 100 ppm.

The wave-shifting crystals may be luminescent particles such as down-converting phosphors or up-converting phosphors. A phosphor is a substance that exhibits the phenomenon of luminescence; it emits light when exposed to some type of radiant energy. The term is used both for fluorescent or phosphorescent substances which emit light on exposure to ultraviolet or visible light, and cathodoluminescent substances which emit light when struck by an electron beam (cathode rays) in a cathode ray tube. When a phosphor is exposed to radiation, the orbital electrons in its molecules are excited to a higher energy level; when they return to their former level, they emit the energy as light of a certain wavelength. The crystals can be configured and tuned to operate over any of a variety of wavelengths of light, including for example in the infrared, visual, and ultraviolet (UV) spectra.

Phosphors may generally be categorized as stokes (down-converting) phosphors or anti-stokes (up-converting) phosphors. Phosphors which absorb energy in the form of a photon and emit a lower frequency (lower energy, longer wavelength) band photon are down-converting phosphors. In contrast, phosphors which absorb energy in the form of two or more photons in a low frequency and emit in a higher frequency (higher energy, shorter wavelength) band are up-converting phosphors. Up-converting phosphors, for example, may be irradiated by near infrared light, a lower energy, longer wavelength light, and emit visible light which is of higher energy and a shorter wavelength. Phosphors may also be categorized according to the nature of the energy which excites the phosphor. For example, phosphors which are excited by low energy photons are called photoluminescent and phosphors which are excited by cathode rays are called cathodluminescent.

The wave-shifting particles of the invention may have different optical properties based on their composition, their size, and/or their morphology (or shape). The particles can be configured/tuned to react to, i.e. be excited by, one or more wavelengths of light. In that way, the particles can be configured to have a unique and specific set of light wavelengths by which they can be interrogated. The particles can also be configured/tuned to emit light having any of a variety of emission characteristics, including for example emission at a defined wavelength or within one or more defined wavelength ranges/bands, emission having a defined rise time, emission having a defined decay time, emission having a defined maximum intensity when interrogated by a light source of a defined intensity, emission having a defined intensity at a given time, emission having defined dimensions (e.g. by controlling the size of the particles), emission in a defined spatial pattern (e.g. by applying the crystals to the substrate in a defined pattern), or any combination thereof. Most of these optical properties can be tuned through alterations to the composition, size, and/or morphology of the particles.

In other embodiments, the particles need not have a customized optical property, but rather may be applied to the metal component in a unique pattern such that the pattern of their emission can be used to identify and/or authenticate the product when appropriately interrogated. Any combination of the above is also contemplated, making it possible to provide an almost infinite number of individual products or sets of products with crystals that produce a unique emission associated with that specific product or that specific set of products.

In some embodiments, for example, one or more products may be provided with crystals having an emission profile that identifies a particular manufacturer, a particular product, a particular nation or region of the world in which the product is approved for sale/use, or any combination thereof. Moreover, the crystals can be applied to the products discretely so as not to interfere with the aesthetic and/or physical properties of the product.

The wave-shifting crystals are crystalline in structure. In some embodiments, the wave-shifting crystals may comprise a pure crystalline phase or lattice, e.g. a rare earth (RE)-containing lattice, a uniform or substantially uniform size, and/or a uniform polyhedral morphology.

Depending on their composition, monodisperse particles of the invention may have crystal symmetries of, but not limited to, tetragonal bipyramids, hexagonal prisms, rods, hexagonal plates, ellipsoids, trigonal prisms, and triangular plates which determine the uniform polyhedral morphologies of the particular particles. Due to their relatively uniform size and shape, the monodisperse particles may self-assemble into superlattices.

The rare-earth elements are a set of seventeen silvery-white soft heavy metals, the majority of which occur in the lanthanide family (lanthanum (La), cerium (Ce), praseodymium (Pr), neodymium (Ne), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu)). Scandium (Sc) and yttrium (Y) are also considered rare-earth elements because they tend to occur in the same ore deposits as the lanthanides and exhibit similar chemical properties, despite having different electronic and magnetic properties.

In some embodiments the lattice may contain yttrium (Y) or a lanthanide (Ln) in its +3 oxidation state. The charge is balanced in the lattice by the presence of an anion such as a halide (fluoride, F−, being preferred), an oxide, an oxysulfide, an oxyhalide (e.g., OCl), a sulfide, etc. Alkali metals, i.e., lithium (Li), sodium (Na), potassium (K), rubidium (Rb), and cesium (Cs) and/or alkali earth metals beryllium (Be), magnesium (Mg) calcium (Ca), strontium (Sr), and barium (Ba) may also be a component of the host lattice. The alkali metals or alkaline earth metals are often called “lattice modifiers.” For the synthesis of monodisperse particles of the invention, the alkali metal or alkaline earth metal present in the lattice may determine the crystal symmetry providing morphological control over the particles as well as independent tunability of a particle's other properties, such as the optical properties of a luminescent particle. For example, the crystal symmetry of LiYF₄, NaYF₄, and KYF₄ are tetragonal, hexagonal, and trigonal, respectively. The chemical composition of the particles of the invention provides unique polyhedral morphologies. Representative yttrium-containing lattices include, but are not limited to LiYF₄, BaYF₅, BaY₂F₈NaYF₄, KYF₄, Y₂O₂S, Y₂O₃, and the like. A lanthanide-containing lattice may be one having any element of the lanthanide series. Representative lanthanide-containing lattices include, but are not limited to, LaF₃, CeF₃, PrF₃, NeF₃, PmF₃, SmF₃, EuF₃, GdF₃, Tb F₃, DyF₃, HoF₃, ErF₃, TmF₃, YbF₃ Lu F₃, NaGdF₃, Gd₂OS₂, LiHoF₄, LiErF₄, CeO, SrS, CaS, GdOCl, and the like.

In some embodiments, the host lattice may be combined with a light emitting dopant. For purposes of the present disclosure, a dopant is a substance that absorbs primary light energy originating from the light source and emits secondary light of a secondary wavelength in response to said primary light energy. When used in combination with a host lattice, the dopant typically is an elemental substitute in the host lattice crystal, serving as a substitute for another element. The element being replaced depends on the composition of the host lattice. For the yttrium-containing or lanthanide-containing lattices used in the particles of the invention, the dopant is often a rare earth metal, quite often a lanthanide or combination of lanthanides, such as Y, Gd, and La (although the dopant is different from the rare earth in host lattice). The dopant element is generally of the same charge and also generally at a small level compared to the element that it is replacing. For example, in a host lattice-dopant combination of NaYF₄:Yb,Er, ytterbium and erbium are the dopants and NaYF₄ is the host lattice material. The ytterbium ions and erbium ions are substituted in for the yttrium ions in the host lattice material. In a host lattice-dopant combination, the phosphor generally substitutes another element for one in the host lattice in a small percentage that gives optical emission properties. A phosphor serving this purpose can comprise a single dopant or can comprise multiple dopants, and one of the dopants might act as a sensitizer. When present, a sensitizer ion is the primary absorber for the phosphor, but is not the main emitter. The energy that the sensitizer absorbs is transferred to the main active emitter ion (main dopant) through non-radiative transfer.

Down-converting inorganic phosphors include rare earth element doped oxides, rare earth element doped oxysulfides, and rare earth element doped fluorides. Examples of down-converting phosphors include, but are not limited to Y₂O₃:Gd, Y₂O:Dy, Y₂O₃:Tb, Y₂O₃:Ho, Y₂O₃:Er, Y₂O₃:Tm, Gd₂O₃:Eu, Y₂O₂S:Pr, Y₂O₂S:Sm, Y₂O₂S:Eu, Y₂O₂S:Tb, Y₂O₂S:Ho, Y₂O₂S:Er, Y₂O₂S:Dy, Y₂O₂S:Tm, Y₂O₂S:Eu (red), Y₂O₃:Eu (red), and YVO₄:Eu (red). Other examples of down-converting phosphors are sodium gadolinium fluorides doped with other lanthanides, e.g., NaGdF₄: Tb, wherein the Tb can be replaced with Eu, Dy, Pr, Ce, etc. Lanthanide fluorides are also known as down-converting fluorides, e.g., TbF₃, EuF₃, PrF₃, and DyF₃.

Up-converting phosphors derived from rare earth-containing host lattices, such as described above, doped with at least one activator couple comprising a sensitizer (also known as an absorber) and an emitter. Examples of up-converting phosphor host lattices include: sodium yttrium fluoride (NaYF₄), lanthanum fluoride (LaF₃), lanthanum oxysulfide, RE oxysulfide (RE₂O₂S), RE oxyfluoride (RE₄O₃F₆), RE oxychloride (REOCI), yttrium fluoride (YF₃), yttrium gallate, gadolinium fluoride (GdF₃), barium yttrium fluoride (BaYF₅, BaY₂ F₈), and gadolinium oxysulfide, wherein the RE can be Y, Gd, La, or other lanthanide elements. Examples of activator couples are selected from: ytterbium/erbium, ytterbium/thulium, and ytterbium/holmium. Other activator couples suitable for up-conversion may also be used. By combination of rare earth-containing host lattices with just these three activator couples, at least three phosphors with at least three different emission spectra (red, green, and blue visible light) are provided. Generally, the absorber is ytterbium and the emitting center can be selected from: erbium, holmium, terbium, and thulium; however, other up-converting phosphor particles of the invention may contain other absorbers and/or emitters.

The molar ratio of absorber: emitting center is typically at least about 1:1, more usually at least about 3:1 to 5:1, preferably at least about 8:1 to 10:1, more preferably at least about 11:1 to 20:1, and typically less than about 250:1, usually less than about 100:1, and more usually less than about 50:1 to 25:1, although various ratios may be selected by the practitioner on the basis of desired characteristics (e.g., chemical properties, manufacturing efficiency, excitation and emission wavelengths, quantum efficiency, or other considerations). For example, increasing the Yb concentration slightly alters the absorption properties, which may be useful for some applications. For instance, by increasing the Yb concentration, one example of a phosphor particle can be configured to be excited at 915 nm instead of 980 nm. The ratio(s) chosen will generally also depend upon the particular absorber-emitter couple(s) selected, and can be calculated from reference values in accordance with the desired characteristics. It is also possible to control over particle morphologies by drastically changing the ratio of the activators without the emission properties changing drastically for most of the ratios but quenching may occur at some point.

The optimum ratio of absorber (e.g., ytterbium) to the emitting center (e.g., erbium, thulium, or holmium) varies, depending upon the specific absorber/emitter couple. For example, the absorber: emitter ratio for Yb:Er couples is typically in the range of about 20:1 to about 100:1, whereas the absorber: emitter ratio for Yb:Tm and Yb:Ho couples is typically in the range of about 500:1 to about 2000:1. These different ratios are attributable to the different matching energy levels of the Er, Tm, or Ho with respect to the Yb level in the crystal. For most applications, up-converting phosphors may conveniently comprise about 10-30% Yb and either: about 1-2% Er, about 0.1-0.05% Ho, or about 0.1-0.05% Tm, although other formulations may be employed.

Some embodiments of the invention employ inorganic phosphors that are excited by infrared radiation of about 950 to 1000 nm, alternatively about 960 to 980 nm. For example, but not by limitation, a microcrystalline inorganic phosphor of the formula YF₃:Yb_{0.10}Er_{0.01} exhibits a luminescence intensity maximum at an excitation wavelength of about 980 nm.

Up-converting phosphors of some embodiments may have emission maxima that are in the visible range. For example, specific activator couples have characteristic emission spectra: ytterbium-erbium couples have emission maxima in the red or green portions of the visible spectrum, depending upon the phosphor host; ytterbium-holmium couples generally emit maximally in the green portion, ytterbium-thulium typically have an emission maximum in the blue range, and ytterbium-terbium usually emit maximally in the green range. For example, Y_{0.80}Yb_{0.19}Er_{0.01}F₂ emits maximally in the green portion of the spectrum.

In some embodiments, the wave-shifting crystals may be selected from amongst those described in U.S. Pat. No. 10,273,407 B2, the description of which is incorporated herein by reference.

Properties of the crystals can be tuned in a variety of ways. As discussed above, the characteristic absorption and emission spectra of the crystals may be tuned by adjusting their composition, e.g., by selecting a host lattice, and/or by doping. In addition to the characteristic absorption and emission spectra that can be obtained, the rise and decay times of the light emitted by the crystals can also be tuned by controlling particle size and morphology. The rise time is measured from the moment the first excitation photon is absorbed to when the first emission photon is observed. The decay time is measured by the slope of the emission decay, or the time it takes for the phosphor to stop emitting once the excitation source is turned off. This is also described as the time it takes for depletion of electrons from the excited energy levels.

Any of a variety of emission properties may be used to provide crystals having a unique, identifiable emission fingerprint. For instance, in some embodiments the power dependence of the crystals may be utilized. When interrogated at a first power density the crystals may produce a certain amount, i.e. intensity, of light and when interrogated at a second power density the crystals may produce a different amount, i.e. intensity, of light. The effect of interrogation power on some rare earth doped crystals is nonlinear. The difference between the emission intensities at different power densities can therefore provide a unique characteristic of the crystals.

A number of rare-earth doped crystals have been developed and tested for their ability to provide unique optical emissions. In one example, a NaYF₄ crystal lattice was doped with each of the following dopants to produce five unique crystals: Er and Yb; Tm and Yb; Nd and Yb; Ho and Yb; Pr and Yb. Each unique crystal was compounded into a polymeric resin at a 100 to 1 ratio to produce samples having a 5 ppm loading of one of the unique crystals. The samples containing the crystals were then excited with pulsed infrared (IR) light and the optical responses of the crystals were captured and analyzed. The optical properties of the emissions of each of the five different crystals were sufficiently different from one another to distinguish each sample from one another.

In another example, a NaLiF crystal lattice was doped with Nd to produce substantially uniform crystal particles having a particle size of about 50 nm×30 nm. The crystals were then blended into a PMMA ink jet formulation and applied to the outer surface of a substrate. The ink coating is not visible on the resulting sample. By changing the dimensions of the crystal and the concentration of the rare earth dopant, each unique uniform crystal set produces a unique optical signature, or fingerprint. This can be identified by a combination of rise time, decay time, and the power dependence of the crystal, e.g. when interrogated at a power density of 1 mW per mm² the crystals will produce a certain amount, i.e. intensity, of light and when interrogated at a power density of 2 mW per mm² the crystals will produce a different amount, i.e. intensity, of light. The effect of interrogation power on these rare earth doped crystals is nonlinear and the difference between the power densities can be utilized in the determination of the unique characteristics of the crystals.

Embodiments of the present invention are directed to the use of wave-shifting crystals, such as rare earth doped crystals, in products, and more specifically in metal components of high-value products such as watches, jewelry, handbags, and other luxury or designer goods, and/or in precious metals identified as having a certain purity and/or certain properties, to provide a discrete method to authenticate and track the goods or metals. The crystals may be incorporated as an additive to the metal during the manufacturing process. Once incorporated into the metal, the metal may be interrogated with a light-emitting device and optionally a light-detecting device to authenticate the product.

In various embodiments, the product can be interrogated by a hand-held or industrial device, such as those disclosed in U.S. Pat. No. 11,138,612 B2 for example, to track and/or authenticate the product.

Aspects of the present disclosure are also directed to methods for tracing and/or authenticating a product, e.g. a luxury good, having a metal component (which should be understood as including products made entirely of metal), be incorporating wave-shifting marker crystals into at least a portion of the metal component of the product. A metal material used to produce a product may be provided with rare earth doped crystals having one or more predetermined luminescence characteristics. At any of a variety of stages of the life cycle of the product, the product may be interrogated to determine if the rare earth doped crystals are present and whether the one or more predetermined luminescence characteristics are satisfied. If the rare earth doped crystals are present and satisfy the one or more predetermined luminescence characteristics, than the product will be positively identified.

The product can be interrogated by applying light having one or more wavelengths that are known to excite the rare earth doped crystals that are incorporated into at least a portion of the metal of the product, thereby exciting the rare earth doped crystals and causing them to luminesce. The luminescence characteristics of the light emitted by the rare earth doped crystals is then detected and compared against the predetermined characteristics to ensure that they match.

In some embodiments, the detection and comparison may be done manually. For instance where the light emitted by the rare earth doped crystals is in the visible spectrum and a user can determine whether the one or more predetermined luminescence characteristics that correspond with the product is present. In other embodiments, the detection and comparison may be performed-at least in part-using a device that has light detection and analysis elements. The use of a detector device may be necessary for instance where an important component of the light emitted by the rare earth doped crystals is not in the visible spectrum, e.g. where at least one of the relevant luminescence characteristics that correspond with the product is in the ultraviolet or infrared spectrum.

In some embodiments, the product may be configured so that the crystals can be interrogated and the emission detected by a smartphone, for instance a smartphone containing an IR illuminator (commonly used for facial recognition) and/or a Vertical-Cavity Surface-Emitting Laser (VCSEL) to excite the crystals and/or a CMOS camera to capture the emission profile of the crystals. For example, the VL53L0X Time-of-Flight (ToF) laser ranging and gesture detection sensor/module, which may be incorporated into a mobile device such as a smartphone, utilizes a VCSEL emitter.

A light map image of an emission profile may be analyzed by one or more processors, such as within the smartphone, having appropriate software to convert the captured emission into the data associated with that specific optical emission profile, e.g. to identify a product or confirm/deny a previous identification of a product for authentication purposes.

In some embodiments, interrogation may be by CW or pulsed laser diodes of various (one or more) wavelengths ranging from UV to Mid Infrared. In some embodiments, interrogation may be by CW or pulsed LED of various (one or more) wavelengths ranging from UV to Mid Infrared. In some embodiments, interrogation may be by Pulsed LED light or laser currently used in smart phone devices. In some embodiments, filtration of an excitation source will be utilized by modulation of the sources and/or optical filtration of the excitation light.

In some embodiments, detection may be by a hyperspectral imaging camera capable of pixel by pixel analysis of both spectral emission as well as rise and decay times. In some embodiments, detection may be by Avalanche Photodiode (APD), which may provide analysis of both spectral emission as well as rise and decay times. In some embodiments, detection may be by a standard CMOS camera, such as those utilized in smart phone devices.

Any of a variety of predetermined luminescence characteristics may be used to identify the product. For instance, it may simply be required that the light emitted by the rare earth doped crystals falls within one or more defined wavelength ranges/bands. Using a visible light wavelength as an example, it may simply be required that the light emitted by the rare earth doped crystals has a certain color or combination of colors, each of which can be quantified. Additionally or alternatively, it may be required that the light emitted by the rare earth doped crystals has a rise time falling within a predetermined and defined range and/or a decay time falling within a predetermined and defined range (typically on the scale of microseconds to milliseconds). Additionally or alternatively, it may be required that the light emitted by the rare earth doped crystals falls within a predetermined and defined maximum intensity range. Additionally or alternatively, it may be required that the light emitted by the rare earth doped crystals falls within a predetermined and defined intensity range after a defined period of time. Additionally or alternatively, it may be required that the light emitted by the rare earth doped crystals is in a defined spatial pattern, e.g. forms a specific shape, letter, or word or forms a scannable code (which may then be scanned as a further confirmation step). Additionally or alternatively, it may be required that the wave-shifting crystals are excited by light within one or more predetermined and defined wavelengths. In some examples, in fact, a wave-shifting crystal may need to be interrogated by a light of a first wavelength followed by a light of a second wavelength in order to excite the crystal and cause an optical conversion. Because the rare earth doped crystals may be tuned to have a variety of different light emitting properties, the particular luminescence characteristic(s) and/or the number of different characteristics to be detected may be selected for a desired application.

As described above, the wave shifting crystals may each have a specific optical signature, or fingerprint, that can be programmed by precise compositional control of the particle structure. To ensure proper analysis of the light map and the different optical signatures from each of the compositions, the particle-to-particle variation for a single composition should be minimal allowing for multiplexed signatures of high levels. Accordingly, in some embodiments it is important for the crystals to have uniform or substantially uniform (within a range of uniformity that the emission profile of the crystals can be detected and determined to be associated with the correct data with which that emission profile is associated) compositions, sizes, etc., or a combination thereof. For example, by controlling the amount of one or more dopants in a given crystal, the decay time may be customized; however, it is important that the decay time of each particle within that crystal set has a substantially uniform amount of the one or more dopants in order to ensure that the decay time is consistent throughout the individual crystal particles.

The wave shifting crystals may themselves have multiple optical signatures which may be used to provide multiple layers of authentication or data recovery.

Accordingly, a product may thus be provided with wave shifting crystals having precisely engineered optical properties that allow for multiple layers of authentication or data recovery.

A first example layer of data identification and/or authentication may focus on the unique spectral (absorption and/or emission) properties of the wave shifting crystals. When the crystals are subsequently exposed to the appropriate excitation wavelength(s), they will emit a distinct optical profile that may be associated with a point or set of data, e.g. identification data. Encryption algorithms may be applied to the light map to associate the distinct optical profile with the point or set of data.

A second example layer of data identification and/or authentication may focus on the positioning of the crystals within a light map. For example, one or more unique crystals can be applied to a product in a method that enables random dispersion of the crystals. When the crystals are subsequently exposed to the appropriate excitation wavelength(s), they may also be mapped based on the location of each crystal in the light map, such that the locations of the crystals is associated with a point or set of data, e.g. identification data. A random distribution of particles allows for a unique pattern to each product. This pattern will be stored as an image file and encrypted for future analysis once the product leaves the manufacturing facility. Encryption algorithms may be applied to the light map to associate the positioning of the crystals within the light map with the point or set of data.

A third example layer of data identification and/or authentication may focus on the unique emission lifetime of the crystals. For example, the same light map captured above may be used to localize, and subsequently measure, the unique lifetime properties of the wave shifting crystals. The lifetimes of the crystals are defined as the rise and decay times at a particular emission wavelength. Each emission spectra can be programmed to have distinct rise and decay times that may be associated with a data point or set of data, e.g. identification data. Encryption algorithms may be applied to the light map to associate the distinct lifetime profile with the point or set of data.

A fourth example layer of data identification and/or authentication may focus on the excitation power dependent emission properties of the crystals. For instance, the composition of NaYF₄:Yb,Er can have significantly different spectral profiles and peak ratios depending on the power density applied to the crystals. This power density dependence can be controlled via a variety of approaches such as direct composition changes, morphologies, and hetero-structures such as core-shell or core-shell-shell. The power density dependence profile may be associated with a data point or set of data, e.g. identification data. Encryption algorithms may be applied to the light map to associate the distinct power density profile with the point or set of data.

If multiple different crystals and/or multiple optical signatures, such as those described above, are present in the product and generating unique light maps for each optical signature/crystal is desirable, the device that reads the light maps can be modified via software or hardware updates to selectively generate light maps based on precise optical excitation parameters such as wavelength, power density, and laser pulse width.

For instance, a product may include a combination of 3 (A, B, C) rare earth particles each with an identifiable optical signature such as lifetime (rise and decay). All samples A, B, C are excited using the same laser source at 980 nm, each of the three A, B, C samples can have the same spectral emission profiles (peak of ˜540 nm) but when measured by rise and decay time each of the spectral samples will have distinguishable rise and decay times. By adjusting the pulse frequency of the laser and detector it is possible to selectively activate particles using only the programmed pulse rates.

### EXAMPLE 1

In one embodiment, stainless steel in powdered form was mixed with wave-shifting rare earth crystals in accordance with the above present description. The wave-shifting rare earth crystals were provided at a concentration of 3% by mass. The powdered mix was placed in a crucible and heated to 1,550° C. in order to melt the stainless steel. The molten stainless steel, in which the wave-shifting rare earth crystals were distributed, was cooled until the blend was solidified.

An infrared (IR) laser was used to interrogate the wave-shifting crystals in the cooled stainless steel. Surprisingly, a reader was able to detect visible light from each crystal. Further, the reader was able to detect the specific light signature from each of the dispersed crystals, the the result being a unique light map associated with the particular distribution of wave-shifting crystals in the cooled stainless steel.

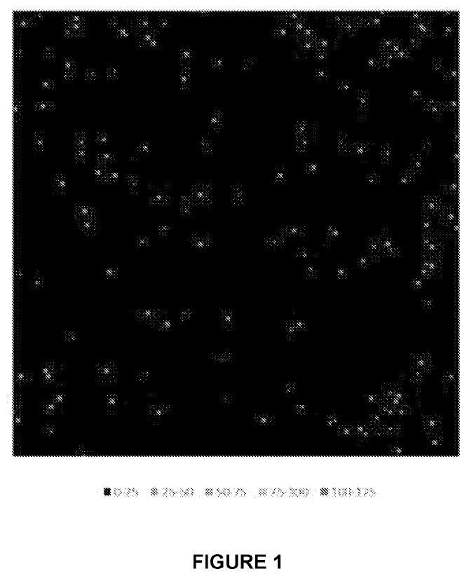

An Example of the light maps detected from the marker-crystal containing stainless steel samples are shown in FIG. 1.

The ability of the wave-shifting, rare earth doped crystals to withstand the extreme temperatures associated with molten metal, in this example 1,550° C. associated with molten stainless steel, and still produce a detectable emission profile when excited was a surprising and unexpected result.

Moreover, because the detector is capable of detecting the specific emission from each of the dispersed crystals, and hence the unique light map for a particular product, the identification and/or authentication of a product need not not dependent solely on the concentration of the crystals in the metal. The use of light maps to identify and/or authenticate products enables the use of a lower concentration of crystals in the metal, which minimizes the affects of the incorporation of the crystals on the metal's physical and aesthetic properties. It is believed that significantly less than the 3 wt. % used in this example may be sufficient to produce a large number of products having unique light maps (to say nothing of the various other layers of authentication that can be worked in by using different combinations of crystals, varying different emission properties of the crystals, and the like).

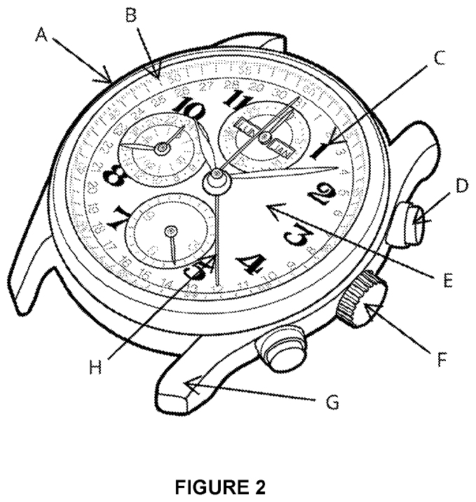

An example of a watch in which wave-shifting crystals have been incorporated is shown in FIG. 2. The wave-shifting crystals may be incorporated into any portion of the watch, including for example the bezel (A), the dial (B), one or more of the hour and/or minute markers (C), one or more of the pushers (D), the crystal (E), the crown (F), one or more of the lugs (G), one or more of the hands (H), the rear face of the watch, a logo identifying the manufacturer of the watch, or any combination thereof.

In further embodiments, instead of being incorporated into a metal component of a product (such as a watch), the wave-shifting crystals may be incorporated into the package for a product. This may have particular application for high-value cosmetic and/or fragrance products, which may be liquids or powders. The wave-shifting crystals may be the same as those described above for incorporation into products and may be utilized in the same manner to track and/or authenticate packaged products.

In some embodiments, wave-shifting crystals may be incorporated into (a) the polymer resin used to manufacture the vessel (in the case of a plastic container) or the borosilicate or aluminosilicate glass used to manufacture the vessel (in the case of a glass container), a closure for the vessel, or any other part of the packaging (e.g. secondary packaging, etc.), (b) an ink or adhesive, e.g. label, that is applied to the exterior of the vessel, to a closure for the vessel, or to any other part of the packaging (e.g. secondary packaging, etc.), (c) a coating that is applied to the interior and/or exterior of the vessel, to a closure for the vessel, or to any other part of the packaging (e.g. secondary packaging, etc.), including for example a coating applied by chemical vapor deposition (CVD) or atomic layer deposition (ALD) and a coating applied by wet deposition methods such as spray coating, spin coating, dip coating, and the like, or (d) a polymeric resin which is incorporated into the vessel, into a closure for the vessel, or to any other part of the packaging (e.g. secondary packaging, etc.), for instance by etching a recess in the vessel, closure, etc. and filling that recess with the polymeric resin.

In some embodiments the wave-shifting crystals may have dimensions less than 20 microns, alternatively less than 15 microns, alternatively less than 10 microns, alternatively less than 8 microns, alternatively less than 6 microns, alternatively less than 5 microns. For instance the D99 of the crystals may be less than 20 microns, alternatively less than 15 microns, alternatively less than 12 microns, alternatively less than 10 microns, alternatively less than 8 microns, alternatively less than 6 microns, alternatively less than 5 microns.

The wave-shifting crystals may be nanoparticles. For instance, the wave-shifting crystals may have dimensions less than 1000 nm (1 micron), alternatively less than 800 nm, alternatively less than 600 nm, alternatively less than 500 nm, alternatively less than 400 nm, alternatively less than 300 nm, alternatively less than 200 nm, alternatively less than 100 nm, alternatively less than 75 nm, alternatively 50 nm or less. In some embodiments, for instance, the wave-shifting nanoparticles may have dimensions between about 3 nm and about 50 nm.

The vessel may be transparent. Transparency is determined by UV spectrometry, also known as UV-Vis Spectrophotometry, using a conventional UV/Vis Spectrophotometer. In many embodiments, it is therefore important that the wave-shifting crystals are sized and present in an amount that does not refract light. By using wave-shifting crystals having appropriate dimensions in appropriate amounts (the smaller the crystals, the higher the concentration may be incorporated before the transparency of the vessel wall is impacted), wave-shifting crystals may be incorporated into or onto a vessel while maintaining transparency. In some embodiments, the wave-shifting crystals may have dimensions of 10 microns or less and may be incorporated into a vessel wall made of a transparent thermoplastic resin at a concentration of about 25 ppm or less, alternatively about 20 ppm or less, alternatively about 15 ppm or less, alternatively about 12 ppm or less, alternatively about 10 ppm or less, alternatively 5 ppm or less. For instance, the wave-shifting crystals may have a D99 less than 10 microns (meaning that 99% of all particles have dimensions less than 10 microns) and/or a D50 of 2 microns (meaning that 50% of all particles have dimensions less than 2 microns) or less. In some embodiments, the wave-shifting crystals may have a D99 less than 10 microns and a D50 of 1 micron or less.

In some embodiments, for example, the portion of the vessel that contains the wave-shifting crystals may have at least 90% transparency, optionally at least 92% transparency, optionally at least 94% transparency, optionally at least 95% transparency, optionally at least 95% transparency, optionally at least 96% transparency, optionally at least 97% transparency, optionally at least 98% transparency, optionally at least 99% transparency, as measured by UV spectroscopy (i.e. UV-Vis spectrophotometry).

In some embodiments, the wave-shifting crystals may be present in the matrix material, e.g. polymer or glass, at a concentration of at least 5 ppm, alternatively at least 10 ppm, alternatively at least 25 ppm, alternatively at least 50 ppm, alternatively at least 100 ppm, alternatively at least 200 ppm, alternatively at least 300 ppm, alternatively at least 400 ppm, alternatively at least 500 ppm. Similarly the wave-shifting crystals may be present in the matrix material at a concentration of 1000 ppm or less, alternatively 750 ppm or less, alternatively 500 ppm or less, alternatively 250 ppm or less, alternatively 100 or less, alternatively 50 ppm or less, alternatively 25 ppm or less, alternatively between about 5 ppb and 100 ppm, alternatively between about 50 ppb and 100 ppm, alternatively between about 100 ppb and 100 ppm, alternatively between about 5 ppb and 75 ppm, alternatively between about 5 ppb and 50 ppm, alternatively between about 5 ppb and 25 ppm, alternatively between about 1 and 100 ppm, alternatively between about 1 and 75 ppm, alternatively between about 1 and 50 ppm, alternatively between about 1 and 25 ppm, alternatively between about 1 and 20 ppm, alternatively between about 1 and 15 ppm, alternatively between about 1 and 10 ppm, alternatively between 5 and 100 ppm, alternatively between about 5 and 75 ppm, alternatively between about 5 and 50 ppm, alternatively between about 5 and 25 ppm, alternatively between about 5 and 20 ppm, alternatively between about 5 and 15 ppm, alternatively between about 5 and 10 ppm.

In embodiments in which transparency is not a factor, the wave-shifting crystals may be present in the matrix material, e.g. polymer or glass, in higher concentrations, e.g. at 0.2% or greater, alternatively 0.3% or greater, alternatively 0.4% or greater, alternatively 0.5% or greater, such that their optical signature can be more easily detected using relatively unsophisticated detection equipment. Similarly, the wave-shifting crystals may be present in the matrix material, e.g. polymer, at concentrations of 3.0% or less, optionally 2.5% or less, alternatively 2.0% or less.

The wave-shifting particles of the invention may have different optical properties based on their composition, their size, and/or their morphology (or shape). The particles can be configured/tuned to react to, i.e. be excited by, one or more wavelengths of light. In that way, the particles can be configured to have a unique and specific set of light wavelengths by which they can be interrogated. The particles can also be configured/tuned to emit light having any of a variety of emission characteristics, including for example emission at a defined wavelength or within one or more defined wavelength ranges/bands, emission having a defined rise time, emission having a defined decay time, emission having a defined maximum intensity when interrogated by a light source of a defined intensity, emission having a defined intensity at a given time, emission having defined dimensions (e.g. by controlling the size of the particles), emission in a defined spatial pattern (e.g. by applying the crystals to the substrate in a defined pattern), or any combination thereof. Most of these optical properties can be tuned through alterations to the composition, size, and/or morphology of the particles.

In other embodiments, the particles need not have a customized optical property, but rather may be applied to the vessel/package in a unique pattern such that the pattern of their emission can be used to identify and/or authenticate the vessel/package when appropriately interrogated. Any combination of the above is also contemplated, making it possible to provide an almost infinite number of individual vessels/packages or sets of vessels/packages with crystals that produce a unique emission associated with that specific vessel/package or that specific set of vessels/packages.

In some embodiments, for example, sets of vessels/packages may be provided with crystals having an emission profile that identifies a particular manufacturer, a particular product, a particular nation or region of the world in which the product is approved for sale/use, or any combination thereof. Moreover, the crystals can be applied to the vessels/packages discretely so as not to interfere with any regulations or requirements of the vessels/packages.

In the case of packages made of plastic, the crystals may be added to the plastic resin during a compounding process, prior to molding the package. In some embodiments the vessel may be made by injection molding using thermoplastic material containing the crystals. In other embodiments the vessel may be made by injection molding a preform from thermoplastic material containing the crystals and then blow molding or stretch blow molding the preform to produce the vessel.

In the case of packages made of glass, the crystals may be added to the molten glass prior to forming the glass into the vessel. In those embodiments, the crystals may need to withstand glass forming temperatures greater than 1,000° F.

In some embodiments, the vessel may be molded out of two polymers, a first transparent polymer and a second polymer which contains the wave-shifting crystals. A first portion/region of the vessel may be molded of the transparent first polymer. A second portion/region of the vessel may be molded of the second, crystal-containing polymer or a combination of the first and second polymers. This may be achieved by a two-shot molding process of either the vessel itself (e.g. if the vessel is injection molded) or a preform (e.g. during injection molding of the preform) which is blow molded into the vessel. The portion/region of the vessel containing the second polymer or a combination of the first and second polymers may not be transparent, but may be positioned strategically where transparency is less desirable. In other embodiments, the vessel may be molded with an in-mold label or component containing the crystals. The in-mold label or component may also be strategically positioned as described above.

In other embodiments, the crystals may be incorporated in a coating system applied to one or more interior walls and/or one or more exterior walls of the vessel. The coating system may be applied using any of a variety of techniques, including for example wet coating techniques, chemical vapor deposition (CVD), or atomic layer deposition (ALD).

In some embodiments, the coating may be transparent or substantially transparent.

In other embodiments, the coating system may be applied to one or more non-transparent areas formed by using a laser to burn away material from the vessel wall, leaving channels or recesses. The channels or recesses may be gray-scale or, optionally, may be black.

In some embodiments, the non-transparent areas may be human readable text, may be alphanumeric, a scannable code, or a geometric shape. In some embodiments the scannable code may optionally be a bar code or QR code.

In some embodiments, the crystals may be incorporated into a polymeric resin which is applied to one or more channels or recesses in the vessel, closure, or other packaging component. The recess may be formed by laser etching. The polymeric resin may or may not be transparent. In some embodiments, the polymeric resin may comprise an epoxy or be an epoxy.

In some embodiments, the coating may contain crystals at a suitable loading to be read with a mobile reader, optionally a smartphone as described herein.

The crystals can be added in parts per billion (ppb) but may be more desirably added in a parts per million concentration or higher. Desirably, vessel walls molded with the crystals may remain transparent. Similarly, it may be desirable that vessel walls having an interior or exterior coating comprising the crystals may remain transparent.

In some embodiments, the crystals can be incorporated into an ink and then applied, e.g. printed, to the vessel or package. In some embodiments, the ink may be transparent or substantially transparent. In some embodiments, the coating may contain crystals at a suitable loading to be read with a mobile reader, optionally a smartphone as described herein. In one embodiment, for example, the crystals may be blended into an ink at a concentration of 5-10 ppm. The ink can be applied to the package using an ink jet printer, e.g. by loading in an HP25 ink cartridge or equivalent, or a pad printing.

The ink may be applied in a defined pattern. In some embodiments, the pattern may be alphanumeric, a scannable code, or a geometric shape. In some embodiments, the scannable code may optionally be a bar code or QR code.

In some embodiments, the vessel or package can be printed with a scannable code, e.g. a barcode or QR code, that may then be interrogated using a reader at one or more discrete wavelengths based on the specific emission characteristics of the crystals. In other embodiments, the ink can be printed in a specific pattern to create a unique light map when interrogated by a reader. In other embodiments, the crystals can be supplied in a holographic label that can be used for tamper evidence and authentication.

In some embodiments, the wave-shifting crystals can be added to secondary packaging or a label that is applied to the vessel.

1. A product configured to be authenticated and/or tracked by way of producing a light emission having one or more predetermined characteristics, the product comprising:
a metal component, in which at least a portion of the metal component comprises a metal material containing wave-shifting marker crystals configured to emit light having one or more characteristics by which the product may be identified.

2. (canceled)

3. The product of claim 1, wherein the wave-shifting marker crystals are rare earth doped crystals.

4. The product of claim 1, in which the metal material is stainless steel or an alloy thereof, gold or an alloy thereof, platinum or an alloy thereof, silver or an alloy thereof, or any combination thereof.

5. The product of claim 1, in which the product is a watch, an item of jewelry, or a pair of eyeglasses or sunglasses.

6.-8. (canceled)

9. The product of claim 1, in which the wave-shifting marker crystals are distributed in the metal material to produce a unique light map when excited.

10. (canceled)

11. The product of claim 1, in which the presence of the wave-shifting marker crystals does not substantially change the physical properties of the metal component.

12. The product of claim 1, wherein the wave-shifting marker crystals are configured and distributed in the metal material such that, when the wave-shifting marker crystals are unexcited, the presence of the wave-shifting marker crystals cannot be detected by the average human eye.

13. The product of claim 1, wherein the wave-shifting marker crystals are configured and distributed in the metal material such that the emission of individual crystals can be detected.

14. The product of claim 1, wherein the marker crystals have dimensions/diameters of 50 microns or less.

15. The product of embodiment claim 14, wherein the marker crystals have dimensions/diameters between 0.5 and 10 microns.

16. The product of claim 1, in which the wave-shifting marker crystals comprises a first wave-shifting marker crystal and a second wave-shifting marker crystal, wherein the first wave-shifting marker crystal and the second wave-shifting marker crystal produce emissions having one or more different properties; and
wherein the wave-shifting marker crystals are configured and distributed in the metal material such that a ratio between the first wave-shifting marker crystal and the second wave-shifting marker crystal can be determined when the wave-shifting marker crystals are excited.

17. (canceled)

18. The product or package of claim 1, in which the marker crystals are configured/tuned to react to one or more specific wavelengths of light.

19. The product of claim 1, wherein the marker crystals are configured to produce an emission in one or more defined wavelength ranges; the marker crystals are configured to have a defined rise time, decay time, or both; the marker crystals are configured to produce an emission having an intensity within a defined range; the marker crystals are configured to produce an emission having dimensions within a defined range, or any combination thereof.

20.-37. (canceled)

38. The product of claim 3, in which the rare earth doped crystals comprise a rare earth element-containing lattice and a dopant.

39. The product of claim 38, wherein the rare earth element-containing lattice contains a first rare earth element and the dopant comprises a second rare earth element, whereby the second rare earth element differs from the first rare earth element.

40.-45. (canceled)

46. The product of claim 3, in which the rare earth doped crystals comprise a lattice and one or more rare earth element dopants.

47.-54. (canceled)

55. The product of claim 1, in which the wave-shifting crystals are configured to produce an emission in response to interrogation by a device having an IR illuminator, a VCSEL, an LED light, or a combination thereof.

56. The product of claim 1, in which the wave-shifting crystals are configured and present in an amount to produce an emission that is readable by a device having a CMOS sensor or CMOS camera.

57.-76. (canceled)

77. A method of authenticating and/or tracking a product, the method comprising:
providing a product according to claim 1;
interrogating the product to determine if the wave-shifting marker crystals produce an emission profile have one or more luminescence characteristics;
identifying and/or authenticating the product based on the results of the interrogation.

78. The method of claim 77, wherein the one or more luminescence characteristics comprises a light map produced by the specific distribution of individual wave-shifting crystals in the metal material.

79.-93. (canceled)
